(19) United States
(12) Patent Application Publication
(10) Pub. No.: US 2010/0262444 A1
(43) Pub. Date: Oct. 14, 2010

(54) RISK ANALYSIS SYSTEM AND METHOD

(75) Inventors: Manjit S. Atwal, Brampton (CA); Senthil K. Chinnathambi, Fremont, CA (US); Ravikumar Subbarayan, Fremont, CA (US)

Correspondence Address: Fountainhead Law Group P.C.;Chad R. Walsh, 900 LAFAYETTE STREET, SUITE 301, SANTA CLARA, CA, 95050, US

(73) Assignee: SAP AG, Walldorf (DE)

(21) Appl. No.: 12/423,497

(22) Filed: Apr. 14, 2009

(51) Int. Cl. G06Q 10/00

(52) U.S. Cl. 705/7

(57) ABSTRACT

In one embodiment the present invention includes a computer-implemented method comprising retrieving user account data records from an external system. Each user account data record comprises actions a user is authorized to perform in the external system, and for each action, permissible data manipulation activities the user is capable of performing for a corresponding action. Risk analysis rules may be applied against the user account data records. Each risk analysis rule may include different function-based sub-rules. Each risk analysis rule may apply a different function-based sub-rule to each different action in a particular user account data record, and each function-based sub-rule may be verified based on a particular action and the permissible data manipulation activities associated with said particular action. The risk analysis rule is verified if all of the different function-based sub-rules for the different actions are verified.

### BACKGROUND

The present invention relates to computer implemented processes and systems including software, and in particular, to a risk analysis system and method.

Organizations have always had a need to monitor their business activities. In the wake of financial scandals like Enron and the enactment of Sarbanes-Oxley, organizations have increasingly turned to governance, risk management, and compliance (GRC) and separation of duties principles to manage and regulate their business activities. Generally, the organizations use these concepts to detect, prevent, and remedy fraud, crime, and other illicit behavior that may occur within an organization.

Risk analysis software may be used to detect the possibility of unwanted behavior occurring (i.e. risks) before they actually occur within an organization, particularly in the context of enterprise systems. Generally, many actions (i.e., transactions or tasks) can be performed on an enterprise system. For example, possible actions include creating a vendor, paying a vendor, creating a user, or approving a document. In addition, data may need to be accessed in order to perform an action. Thus, completion of an action may require the authority to access the data associated with the action. A user of the enterprise system may be given authority to perform a particular action, and in instances where data needs to be accessed to perform the action, the user may also be given authority to access the data associated with performing the action. Risk analysis software may be used to apply and enforce rules created in accordance with current laws, best practices, or other business objectives to ensure that authorization privileges for performing actions and/or accessing data, for example, do not create risks for the organization.

One problem with traditional risk analysis techniques is that existing approaches result in either false positives or false negatives, thereby reducing the accuracy of the system. False negatives happen when a rule violation has occurred, but it was not detected by the risk analysis software. False positives happen when a rule violation has not occurred, but the risk analysis software indicates one has occurred. From a risk perspective, organizations generally prefer to reduce false negatives because such results correspond to an unknown potential liability. Accordingly, risk analysis systems may be configured in favor of eliminating false negatives. As a result, the number of false positives increase, and the cost to operate the system increases because each false positive needs to be investigated manually.

What is needed is a method for increasing the accuracy of detecting rule violations that reduces produce false positives or false negatives. The present invention solves these and other problems by providing improved systems and methods for performing risk analysis.

### SUMMARY

Embodiments of the present invention improve risk analysis processing. In one embodiment the present invention includes a computer-implemented method comprising retrieving user account data records from an external system. Each user account data record comprises actions a user is authorized to perform in the external system and, for each action, permissible data manipulation activities the user is capable of performing for a corresponding action. Risk analysis rules may be applied against the user account data records. Each risk analysis rule may include different function-based sub-rules. Each risk analysis rule may apply a different function-based sub-rule to each different action in a particular user account data record, and each function-based sub-rule may be verified based on a particular action and the permissible data manipulation activities associated with said particular action. The risk analysis rule is verified if each of the different function-based sub-rules for the different actions are verified.

In one embodiment, each action corresponds to a software application page a user is authorized to access, and the permissible data manipulation activities restrict the manipulation of data fields in said application page by said user.

In one embodiment, each action is stored as an action code in said user data account records.

In one embodiment, the one or more permissible data manipulation activities said user is capable of performing for a corresponding action are permission objects associated with said action codes, said permission objects having values indicating the activities said users are capable of performing in said one or more software systems.

In one embodiment, the permission objects correspond to specific data fields of an application page and the permission object values specify one or more data manipulations a user may perform on said data fields, and wherein each function-based sub-rule comprises a Boolean combination of one or more permission object values and at least one action code value.

In one embodiment, each function-based sub-rule comprises a Boolean combination of one action code and a plurality of permission objects each having specified values.

In one embodiment, user account data records from two or more external software systems correspond to a single user, the method further comprising merging said account data records prior to applying said risk analysis rules.

In one embodiment, the method further comprises retrieving a plurality of risk analysis rules and, based on the actions in the retrieve user account data records, eliminating risk analysis rules from said plurality of risk analysis rules to produce said one or more risk analysis rules to be applied against said one or more of said plurality of user account data records.

In one embodiment, the risk analysis rules are eliminated if a risk analysis rule does not include an activity code in any of said user account data records, and wherein the activity codes specify particular application pages in at least one of the external software systems.

In one embodiment, further comprising aggregating the results of each risk analysis rule and sending the aggregated results to a reporting software component.

The following detailed description and accompanying drawings provide a better understanding of the nature and advantages of the present invention.

### BRIEF DESCRIPTION OF THE DRAWINGS

FIG. 1 illustrates a risk analysis system and method according to one embodiment of the present invention.

FIG. 2 illustrates an example of function-level risk analysis according to one embodiment of the present invention.

FIG. 3A illustrates an example relationship between application pages, user authorization data, and function-based sub-rules according to one embodiment of the present invention.

FIG. 3B-E illustrate examples of permission objects processed using function-based sub-rules according to one embodiment of the present invention.

FIG. 4 illustrates a method of analyzing risk according to one embodiment of the present invention.

FIG. 5 illustrates a method of analyzing risk according to one embodiment of the present invention.

FIG. 6 is a block diagram of an example computer system and network 600 for implementing embodiments of the present invention.

### DETAILED DESCRIPTION

Described herein are processes for performing risk analysis. The apparatuses, processes, and techniques described below may be implemented as a computer program (software) executing on one or more computers. The computer program may further be stored on a computer readable medium. The computer readable medium includes computer executable instructions that when executed on a computer system causes the system to perform the processes described below. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

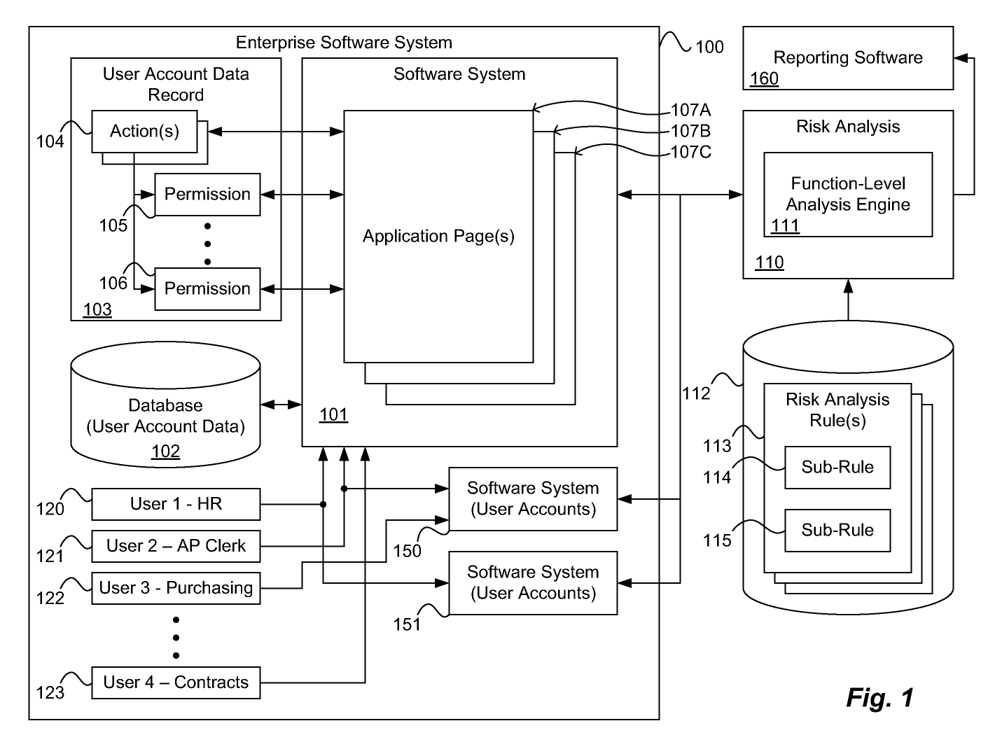

FIG. 1 illustrates a risk analysis system and method according to one embodiment of the present invention. Risk analysis software may be used to uncover risks created by authorization privileges of users of a plurality of software systems, such as an Enterprise Software System 100, for example. Enterprise Software System 100 may include multiple software systems 101, 150 and 151, for example, which may be Enterprise Resource Planning (“ERP”) Applications, Customer Relationship Management (“CRM”) Applications, or other software systems from SAP®, Oracle®, MicrosoftC®, or Saleforce.com®, for example. Examples of Enterprise Software Systems include SAP® ERP, Peoplesoft®, JD Edwards® EnterpriseOne, and Oracle® E-Business Suite. Enterprise Software System 100 may be used to manage and run an organization's computer implemented business processes, which may include order fulfillment or billing, for example. In doing so, Enterprise Software System 100 may need to control various computer implemented business operations like manufacturing, supply chain management, financial management, human resources, and customer relationship management. Furthermore, users (e.g., the organization's employees) may interact with Enterprise Software System 100 in order to execute business actions relating to their job functions or roles.

Numerous users may be set up to use the different software systems. In particular, when a new employee of an organization is hired by a company, the user may be given access to specific functionality within one or more systems to perform his or her job functions or roles within the company. For example, User 1 120 may be an employee in the Human Resources (“HR”) department, and may be given access to software functionality in software systems 101 and 151. Similarly, User 2 121 may be an employee in the Accounts Payable (“AP”) department, and may be given access to software functionality in software systems 101 and 150. Likewise, User 3 122 may be an employee in the Purchasing department, and may be given access to software functionality in software system 150. Finally, user 4 123 may be an employee in the Contracts department, and may be given access to software functionality in software system 101. In most situations, each user may have a number of different functions or roles within the company, and may have access to corresponding software functionality to perform actions relating to such functions/roles.

To perform their job functions using the various software systems available within the company, each user may be given authorization to perform various actions in each software systems. For example, User 3 in Purchasing may be authorized to access a purchase order component of a software system and generate a purchase order for a new or preexisting supplier. Therefore, User 3 may further be given permission to manipulate data so that the amount of the purchase order or the supplier information, for example, can be recorded in the system. Similarly, User 2 in Accounts Payable may be authorized to access an invoice payment component of a software system and pay purchase orders received by the company. As with User 1, User 2 may be given permission to manipulate data corresponding to the action of paying the purchase order so that the supplier's bank information or payment terms (e.g., due on receipt or due 30 days after an invoice date), for example, can be recorded in the system. If the same user had access to both purchase order creation and payment, such a condition would represent a risk of fraud to the company.

The authorizations to perform various actions (i.e., transactions) within each software system are typically stored as user account data in a persistent storage mechanism, such as data repository (e.g., a database 102 in FIG. 1) or another computer readable storage medium. Examples of a data repository 102 include Microsoft SQL Server, IBM, DB2, Oracle Database, and MySQL. For example, when an employee enters the company, an information technology (“IT”) employee may create a new user account on each software system that the new user needs to access, and may define the actions and data manipulation permissions the user may require in order to perform his or her job function or role within the company. Features and advantages of the present invention retrieve and analyze both a users actions and data manipulation permissions across one or more software systems to determine the risk associated with the users access to the company's electronic systems.

FIG. 1 illustrates a user account data record 103 that may be stored in database 102 for accessing functionality of software system 101. The user account data record 103 may include one or more actions 104. In this example, software system 101 may include a plurality of application pages 107A-C for performing various actions (e.g., creating a purchase order or paying an invoice). Therefore, in this example, actions 104 in user account data record 103 may specify particular application pages that a particular user is authorized to access to perform their job function. Each action 104 in data record 103 may further include permissible data manipulation activities the user is capable of performing for a corresponding action. For example, if action 104 authorizes User 2 121 to access an invoice payment application page used for paying an invoice, then permission 105 may grant User 2 the ability to manipulate a data field on the invoice payment application page, such as entering and storing a suppliers bank information, for example. Similarly, permission 106 may grant User 2 the ability to manipulate another data field on the invoice payment application page, such as selecting between one of a plurality of predefined payment terms that are acceptable to the company. It should be noted that different permissions may indicate different permissible data manipulation activities. Using this example, User 2 may have permission to enter and store new supplier bank information, but User 2 may not have permission to enter and store new payment terms. Rather, User 2 only has permission to select existing payment terms in this example.

Embodiments of the present invention include a risk analysis software component 110 that retrieves user account data records from one or more external software systems, such as Enterprise Software System 100. Risk analysis software component 110 may be a stand-alone application or a component of a larger Governance, Risk, and Compliance (“GRC”) Application, for example. Risk analysis software 110 may receive user account data from one or more software systems and access and apply risk analysis rules to the user account data records. Risk analysis rules 113 may be stored in repository 112, such as a database or another computer readable storage medium. Advantageously, according to one aspect of the present invention, risk analysis rules 113 may each include one or more different function-based sub-rules. For example, a risk analysis rule 113 may include a first function-based (or role based) sub-rule 114 directed at analyzing risk for a particular job function within the company. Risk analysis rule 113 may include a second function-based (or role based) sub-rule 115 for analyzing another function the user performs within the company.

In one embodiment, each risk analysis rule 113 applies a different function-based sub-rule to each different action specified in a particular user account data record. For example, if an employee user is set up in an Enterprise Software System 100 to perform the function of “Contract Approval” and another function of “Service Entry Sheet Acceptance”, then the user may have at least two different actions specified in his or her user account data record (e.g., a first action for performing the Contract Approval function and a second action for performing the Service Entry Sheet Acceptance function). Accordingly, a risk analysis rule may be defined that includes a first function-based sub-rule directed at the first specified action in the user account data record (e.g., an action for performing Contract Approval) and a second function-based sub-rule directed at the second specified action in the user account data record (e.g., an action for performing Service Entry Sheet Acceptance). The function-based sub-rules 114 and 115 may separately determine risk based on a user's access to software functionality corresponding to each particular action, for example. In one embodiment, risk analysis rule 113 is verified if all of the different function-based sub-rules (e.g., sub-rules 114 and 115) for the different actions are verified. In one embodiment, the risk analysis rule may only be verified (i.e., satisfied) if each of the function-based sub-rules are separately verified. For example, risk analysis rule 113 may only be verified if the first function-based sub-rule 114 applied against the first action and corresponding data manipulation privileges for performing Contract Approval is verified and if the second function-based sub-rule 115 applied against the second action and data manipulation privileges for performing Service Entry Sheet Acceptance is also verified.

Additionally, in some embodiments, each function-based sub-rule 114 or 115 may be verified based on a particular action and at least one of the permissible data manipulation activities associated with the particular action. For example, if user account data record 103 is retrieved by risk analysis software 110 and a risk analysis rule 113 is applied to the data record, each action 104 specified in the data record may be evaluated using a different function-based sub-rule as described above. Here, action 104 includes permissions 105 and 106, which specify the permissible data manipulation activities a user is capable of performing for action 104. Accordingly, the result of the evaluation of the sub-rule used for action 104 may be based on the action 104 and data specifying the permissible data manipulation activities (e.g., permission 105 or permission 106, or both), for example.

Risk analysis software 110 may include a function-level analysis engine 111. Function-level analysis 111 may receive risk analysis rules 113 from storage 112, and may further receive user account data records 103 from multiple different software systems 101, 150, and/or 151. Analysis engine 111 receives the user data records and applies the data to the rules 113, including each of the sub-rules 114 and 115, for example. If the same user has account information on multiple different software systems, the risk analysis software 110 may merge the data into a single data set to perform the analysis as described in more detail below. If a risk analysis rule is verified (i.e., if the user account data satisfies the rule and sub-rules), then an alert may be generated. In one embodiment, user account data records for numerous users across multiple software systems may be retrieved and processed to analyze risk. The results may be sent electronically from risk analysis software 110 to a reporting software component 160 for review.

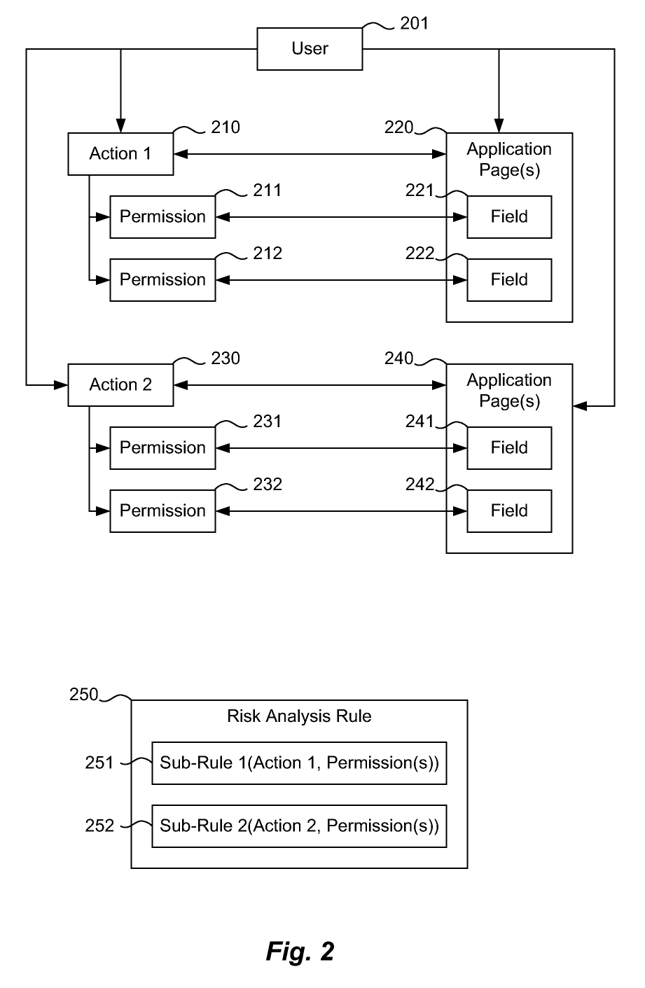

FIG. 2 illustrates an example of function-level risk analysis according to one embodiment of the present invention. First, FIG. 2 shows an example relationship between actions and corresponding permissions in a user account data record and application pages and data fields in a software application. As mentioned above, a user may be set up in one or more software systems according to ajob function (e.g., an Accounts Payable Employee or Purchasing Employee). In this example, a user 201 may be required to perform two (2) actions 210 and 230 to satisfy his or her job function. The first action 210 may require that user 201 be authorized to access one or more particular application pages 220 (e.g., computer program application screens or graphical user interfaces for creating a purchase order). Accordingly, the user's authorization to access application page(s) 220 is specified as an action 210 in the user's account data record (this may be done by the IT person when the employee is hired). This information may be used by the software system to grant the user access to application page 220, for example. Similarly, the second specified action 230 may indicate that user 201 is authorized to access one or more particular application pages 240 to perform another function of his or her job.

Additionally, to perform his or her job function on application page 220, user 201 may be granted certain permission rights to manipulate data in application page data fields 221 or 222. As mentioned above, such permission may be different for different data fields. For example, an HR user may have the right to view (i.e., permission=display) a social security number on an application page used for company employee profiles, whereas other employees may not be granted permission to view such information. As another example, an Accounts Payable user may be granted permission to view vendors, but may not be able to create, select, or modify vendors in a purchase order application page. However, a Purchasing Department user may be granted permission to view and select vendor information in the same purchase order application page of the software application (e.g., if the action corresponds to creating a purchase order). Moreover, a Purchasing Department Management (or Supervising) user may be granted permission to create and/or modify vendor information in the same purchase order application page of the software application. The user's permission to perform data manipulation activities on fields 221 and 222 in application page(s) 220 may be specified separately as permission 211 and permission 212 in the user's account data record. This information may be used by the software system to grant the user rights to manipulate data fields 221 and 222 in application page 220, for example. Accordingly, action 210 may have corresponding permissions 211 and 212, which specify the data manipulation activities that user 201 is capable of performing on application page 220 to execute action 210. Similarly, action 230 may have corresponding permissions 231 and 232, which specify the data manipulation activities that user 201 is capable of performing on application page 240 on data fields 241 and 242 to execute to execute action 230.

Next, FIG. 2 shows an example risk analysis rule 250, including sub-rule 251 and sub-rule 252. In one example embodiment, risk analysis software performs function-level risk analysis by determining an aggregated risk based on separately determined risks, which are each generated by analyzing the scope of a user's authorization to access a software system to perform a particular job function. Here, risk analysis rule 250 aggregates risk specified by function-based sub-rule 251, which is satisfied based on a combination of action 210 and one or more permissions associated with action 210, such as permission 211 or permission 212, or both, for example. In one specific embodiment, action 210 may be a code specifying application page 220 in a software system, and permission 211 and 212 may have values that indicate the permissible data manipulation a user may perform on fields of page 220. Accordingly, sub-rule 251 may be a Boolean combination of codes and values, where sub-rule 251 is verified if a user's account information includes a code in the action field 210 and values in one or more permission fields 211 and/or 212 that satisfy the Boolean combination.

The risk analysis rule and associated sub-rules can be represented by text. The following example is illustrative:
User Account Data Record[Action=ME12, P1=C0, P2=X1].
   Shown is a series of actions and associated permissions, where “ME12” is a code for a particular application page, P1 is a first data manipulation permission for a first data field in the specified application page, C0 is the value of P1 and represents a permission to save data in the first field of the application page, P2 is a second data manipulation permission for a second data field in the specified application page, X1 is the value of P2 and represents a permission to display data in the second field of the application page, and so on. The following function-based sub-rule may be defined:
SubRule=ME12 and P1(C0) and P2(X1).
   The above sub-rule would be satisfied by the user account data record above. Additional sub-rules may be specified for other actions and associated permissions in a user account data record. The results of the sub-rules may, in turn, be combined (e.g., logically) to generate a final risk analysis rule result. Because sub-rules may be specified according to actions and permission rights, and then combined with other similarly generated sub-rule results, a higher level of granularity and flexibility in rule analysis creation and resolution may be achieved to reduce false positives and negatives. The following is an example of combining function-based sub-rules to generate a risk analysis rule result:
Function-based sub-rule 1=ME12 and P1(C0) and P2(C0) and P3(C1 or K1) and P4(Z) and P5(02),
Function-based sub-rule 2=ML81 and P1(A1) and P2(X1 or X2) and P5(02).
   In the above example, ME12 and ML81 may be action codes representing application pages a user may have access to, P1-5 are permissions associated with each application page ME12 and ML81, and the values in parentheses are values of the permissions. If a user account data record is received with a first action value ME12 and with associated permission values that satisfy the sub-rule 1, then the first sub-rule will be satisfied by the user account data, and sub-rule 1 will be verified. Additionally, if the user account data record with a second action value ML81 and with associated permission values that satisfy the sub-rule 2, then the second sub-rule will be satisfied by the user account data, and sub-rule 2 will be verified. The risk analysis rule may be verified as follows:
Risk 1=Function-based sub-rule 1 and Function-based sub-rule 2.
   Accordingly, both function-based sub-rules are evaluated, and if both are verified, then the risk analysis rule “Risk 1” is verified.

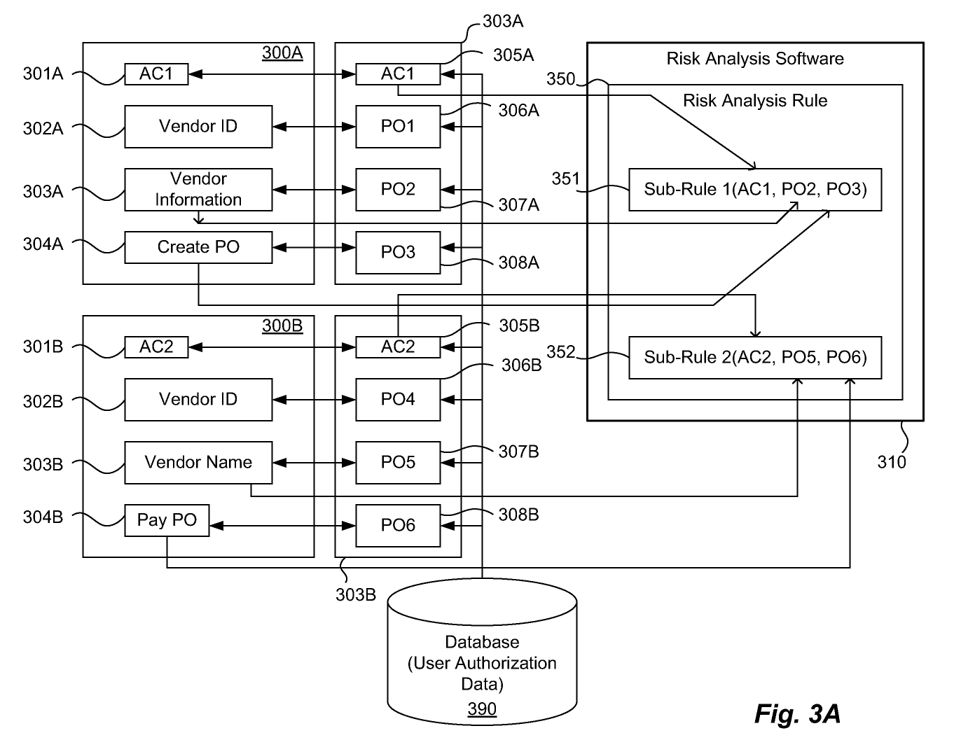

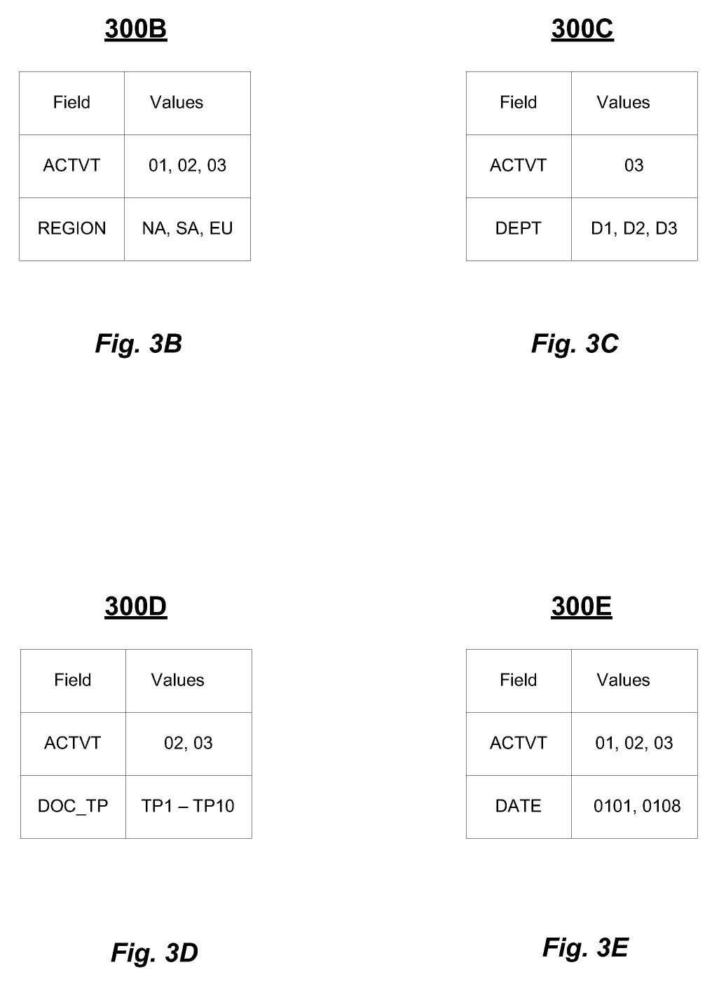

FIG. 3A illustrates an example relationship between application pages 300A-B, user authorization data, and function-based sub-rules according to one embodiment of the present invention. In some embodiments, application pages 300A-B may be associated with an application page identifier (e.g., action codes/transaction codes). An application page identifier may be a value used to identify the application page within a software system. An enterprise software application may contain a plurality of application pages (e.g., screens, windows, forms, documents, or GUI pages). In order to identify a particular application page among a plurality of application pages, each application page may be assigned a unique identifier, which is the action code for the page. In this example, application page 300A is associated with application page action code 301A, and the value of action code 301A is AC1. Similarly, a second application page 300B is associated with an action code 301B, which has a value AC2. The action codes may be used to determine if a particular user is authorized to access the page, as described below.

As mentioned above, each application page 300A and 300B may include one or more data fields. In this example page 300A includes data manipulation fields 302A-304A, which include fields 302A for a vendor ID and 303A for vendor name, respectively. Additionally, example page 300A includes an action button for creating a PO using data from fields 302A and 302B. In this simplified example, user may enter a vendor ID or vendor name and create a purchase order for a pre-existing vendor by mouse-clicking button 304A. Similarly, page 300B includes data manipulation fields 302B and 303B for a vendor ID and vendor name. Action button 304B may be used to pay a PO for a specified vendor. Data manipulation fields may include data entry boxes, drop down menus, electronic buttons, or other mechanisms for presenting and manipulating data on a page of an application.

In certain embodiments of the present invention, each user of the software system may have user authorization data for controlling a user's access to application pages and controlling the user's permission rights to manipulate of data on each page. As mentioned above, authorization data may be stored as user account data records in a database. In this example, the authorization data in a user account includes one or more action codes specifying the application pages in a software application that the user is authorized to access. In other words, if a user account includes an action code having the same value as an action code for an application page, then the user is authorized to access the application page, but if a user account does not include an action code having the same value as an action code for the application page, the user is not authorized to access such page and will not be able to access the page. Referring to FIG. 3A, user authorization data may be stored in database 390 (e.g., in a user's account). Example user authorization data for one user is shown at 303A and 303B. In this example, user authorization data 303A includes an action 305A comprising an action code equal to AC1, which indicates that this user is authorized to access page 300A. Similarly, user authorization data 303B includes an action 305B comprising an action code equal to AC2, which indicates that this user is authorized to access page 300B. The example in FIG. 3A further illustrates the use of permission objects for controlling data manipulation privileges. In some embodiments of the present invention, a permission object may be used as a mechanism to control user data manipulations on application pages. In this example, user authorization data 303A includes three (3) permission objects 306A, 307A, and 308A associated with action 305A. If a user attempts to access an application page, a software system may first compare the action code 305A in user authorization data 303A to determine if the action code matches the action code 301A for the page being accesses. If the action codes match, then access to the page is granted, and the user may receive the page. However, if the page includes data fields, such as data fields 302A-304A, then the system may restrict access to certain user data manipulations based on permissions defined in permission objects. In this example, the user's ability to manipulate data field 302A (“Vendor ID”) is controlled by permission object 306A (“PO1”). Similarly, the user's ability to manipulate data field 303A (“Vendor Name”) is controlled by permission object 307A (“PO2”). Finally, the user's ability to manipulate data field 304A (e.g., whether or not the user has the right to create a PO) is controlled by permission object 308A (“PO3”). Similarly, user authorization data 303B includes action 305B and associated permission objects 306B, 307B, and 308B. These permission objects control the user's ability to manipulate data fields 302B, 303B, and 304B in application page 300B. For example, when a user accesses an application page, the software system may read the action code and data stored in permission objects associated with the action code. The system may grant access to the page based on the action code and may control the user's data manipulation abilities on the page using data values stored in the permission objects, for example. While separate permission objects for each field are shown in this example, other embodiments may use one permission object for multiple data fields or multiple permission objects for a signal field, for example. Accordingly, permission objects may be used to control data manipulation activities. Data manipulation activities may include, but are not limited to, read, write, execute, delete, create, or edit. Examples of permission objects are Oracle™ Profile Options and Peoplesoft™ Data Level Security. A permission object may determine what operation or operations may be performed on data, which particular data may be operated upon, or both.

Features and advantages of the present invention include using user authorization data, including action codes and associated permission objects, in risk analysis rules and sub-rules to assess risk in an enterprise. Risk analysis software system 310 may execute risk analysis rule 350. In this example, risk analysis rule 350 is made up of separate sub-rules 351 and 352. Each risk analysis rule 350 may include multiple sub-rules based on different actions codes. As described above, action codes give users access to particular application pages that the user is required to access to perform their job functions. Accordingly, the action codes in a user's authorization account are representative of each user's job function. Since each risk analysis rule 350 in this example assess risk separately for different action codes using different sub-rules, the analysis is referred to as a “Functional-Level” or “Role-based” risk analysis. As illustrated in FIG. 3A, sub-rule 351 may be a function of the action code 305A and one or more permission objects associated with the action code, such as permission objects PO2 and PO3. Similarly, sub-rule 352 may be a function of the action code 305B and one or more permission objects associated with the action code, such as permission objects PO5 and PO6. As described in more detail below, permission objects may include different fields each having different values and controlling multiple different data manipulation activities. Accordingly, function-level analysis provides a fine level of granularity in rule creation not previously available in existing risk analysis systems, and thereby improves the ability of the risk analysis software to obtain accurate results, while reducing the number of false positive and false negatives.

As mentioned above, determining risk based on user permission to perform data manipulation may include processing risk analysis rules that include permission objects. The follow examples illustrate permission objects in more detail to illustrate the flexibility and granularity that may be achieved by incorporating permission objects and associated action codes into risk analysis function-based sub-rules. As mentioned above, a permission object may be implemented to include one or more fields where a field may specify one or more values. A field and value may determine what operation or operations may be performed on data, which particular data may be operated upon, or both. What a field and its specified value may represent may be based on how the field and value is defined. For example, in FIG. 3B, which illustrates an example of permission object 300B, field ACTVT may be defined to determine what operation or operations may be performed on data. A value of “01” in field ACTVT may determine that a create operation may be performed on data, a value of “02” in field ACTVT may determined that an edit operation may be performed on data, and a value of “03” in field ACTVT may determine that a display operation may be performed on data. Field REGION may determine which particular data may be operated upon. A value of “NA” in field REGION may determine that data related to the North America region may be operated upon, a value of “SA” in field REGION may determine that data related to the South America region may be operated upon, and a value of “EU” in field REGION may determine that data related to the Europe region may be operated upon. Thus, permission object 300B may allow a user to perform create, edit, or display operations on data related to the North America, South America, or Europe regions because that is how the fields and values are defined to represent. Where a field and value are defined to determine which particular data may be operated upon, a value specified in a field may determine, directly or indirectly, which particular data may be operated upon. The FIG. 3B example discussed above is an example where a field and its values indirectly determined which particular data may be operated upon. Field REGION and its values “NA,” “SA,” and “EU” did not determine that the actual data values “NA,” “SA,” and “EU” may be operated on. Rather, field REGION and its values “NA,” “SA,” and “EU” was defined to determine data related to the North America, South America, and Europe regions.

In contrast, FIG. 3C is an example of permission object 300C where a field and its values directly determines which particular data may be operated upon. Field DEPT may be defined such that its specified values are the actual data that may be operated upon. Thus, field DEPT and value “D1” may determine that data “D1” may be operated upon, field DEPT and value “D2” may determine that data “D2” may be operated upon, and field DEPT and value “D3” may determine that data “D3” may be operated upon. Thus, using the same field and value definition for field ACTVT in the FIG. 3C example, permission object 300C may allow a display operation on data “D1,” “D2,” and “D3.” Again, this illustrates that what a field and its specified value may represent may be based on how the field and value is defined. FIG. 3D is an example of permission object 300D where the values specified in a field may be defined to be represented as a range. Field DOC_TP may be defined to determine document types to be operated upon. Field DOC_TP and value range “TP1-TP10” may determine the types of documents that may be operated upon. Thus, using the same field and value definition for field ACTVT in the FIG. 3D example, permission object 300D may allow edit and display operations on the 10 document types TP1 through TP10. What exact document types values “TP1-TP10” represents may be based on how those values are defined.

FIG. 3E illustrates an example of permission object 300E. Permission object 300E is another example where what the values specified in the field represent may be based on how such values are defined. In this example, field DATE may be defined to take two values, a start date and an end date where the two values specified in field DATE may be defined in a month/year format (i.e. MM/YY). Field DATE and its two specified values may determine that data may be operated upon between the two date values. Thus, using the same field and value definition for field ACTVT in the FIG. 3B example, permission object 300E may allow a user to perform create, edit, and display operation on data between 01/01 (January 2001) and 01/08 (January, 2008). Accordingly, a permission object may be implemented to include one or more fields where a field may specify one or more values, and what a field and its specified value may represent may be based on how the field and value is defined. The sub-rules may similarly employ corresponding flexibility to define risk for corresponding actions and thereby improve the risk analysis process.

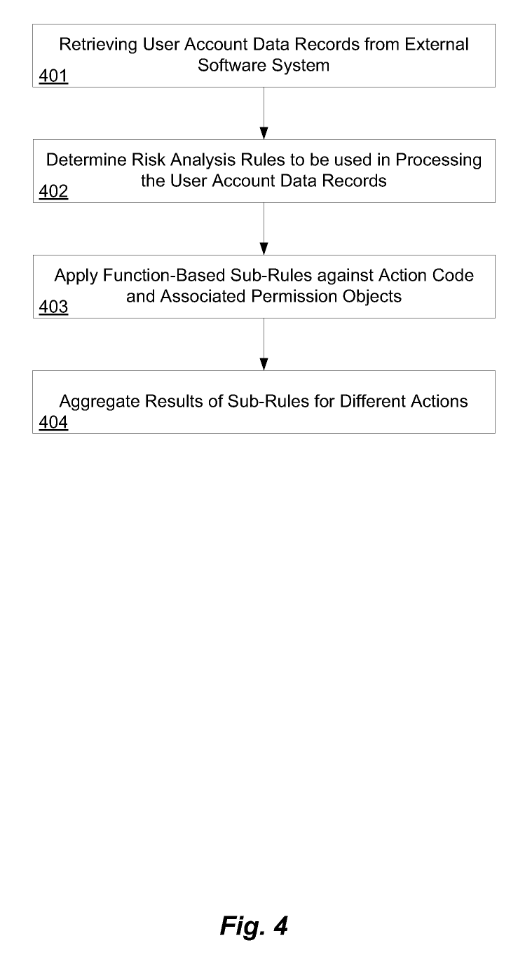

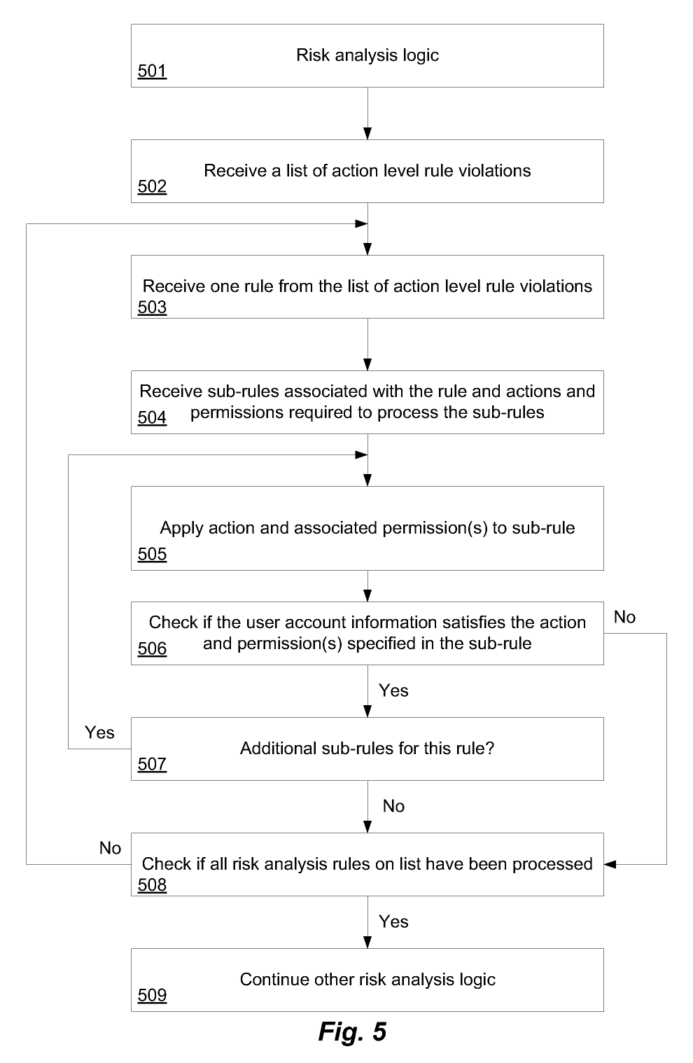

FIG. 4 illustrates a method of analyzing risk according to one embodiment of the present invention. At 401, user account data records are retrieved from an external system. As described above, a risk analysis software component may retrieve user authorization data from an enterprise software system. At 402, risk analysis rules to be used in processing the user account data records are determined. In one embodiment, action level rules may be applied against the user authorization data to determine which risk analysis rules are to be used in processing the data. For example, an action level rule may be based on actions users are authorized to perform. In particular, an action rule may include a Boolean combination of action codes corresponding to sub-rules, for example. If user data satisfies any one of the action level rules, such data may require further analysis by sub-rules. However, if user data does not satisfy one of the action level rules, such data may not include the required actions applicable to the sub-rules. Accordingly, such data need not be further processed by sub-rules. This process is described in more detail in FIG. 5. At 403, function-based sub-rules are applied against action codes and associated permission objects in the user authorization data. Finally, at 404, the results of the sub-rules are aggregated for different action codes and the risk analysis rule result is generated. The results of all risk analysis rules against the entire user data set may be presented in a report, for example.

FIG. 5 illustrates a method of analyzing risk according to one embodiment of the present invention. This method may be performed by function-level analysis engine 111 in FIG. 1. Thus, risk analysis software application 110 has received the rules (rules 113 in FIG. 1) and the user account information (user account information 103 in FIG. 1) of the user account to be analyzed. At 501, risk analysis logic, such as preprocessing, may be performed. For example, step 501 may include retrieving user account data from an Enterprise System, normalizing the data, and retrieving rules, for example, or performing other preprocessing steps. In one embodiment, actions specified in the user data and rules may be examined to eliminate rules. For example, action level rules may be applied to the user account data as described above based on actions, and rules are eliminated if certain actions are not specified a user's account data records. In particular, since a risk may be defined by a rule that is associated with particular application pages through actions (e.g., action codes), the risk analysis logic at step 501 may include processing the specified rules at an action level to determine whether an action level violation has occurred. As a specific example, for each rule, the user account information is checked to see whether it includes action codes specified in the rule. If so, the rule marked as an action level violation. Once all the rules have been checked, the list of action level violations, which specifies risk analysis rules that include actions also found in the user account data, may be received at 502. The risk analysis rules specified in the list are further processed using both actions and permissions.

Next, risk analysis rules are processed individually. For example, at 503, one rule from the list of action level rule violations is received. At 504, sub-rules associated with the rule and actions and permissions required to process the sub-rules may be received. At 505, user account data values for an action and one or more associated permissions specified in a sub-rule are applied against the sub-rule. At 506, the result is checked. If the user account data satisfies the action and permission in the sub-rule, then the process moves to 507. If a sub-rule for a risk analysis rule is not satisfied in this example, then further processing of the risk analysis rule is stopped and the process continues at 508. At 507, the system checks for additional sub-rules for the risk analysis rule being processed. If the risk analysis rule includes additional unprocessed sub-rules, then the process returns to 505 and further sub-rules are processed. If all sub-rules for the risk analysis rule have been processed, then a result for the risk analysis rule is generated and the process moves to step 508. At step 508, the system checks if all risk analysis rules on the list have been processed. If additional rules require processing, the process returns to step 503. If all risk analysis rules have been processed, the process moves to step 509 and additional risk analysis processing may occur, such as report generation, for example.

The following is an example of a risk analysis rule and sub-rules processed in accordance with an embodiment of the present invention:

### Risk Definition (Risk 1):

Function-Based Sub-Rule 1 (Job Function: PO/Contract Approval)
ME28 (TCD) and M_EINK_FRG/FRGGR (CO) and M_EINK_FRG/FRGCO (C1 or K1) and M_BEST_BSA/BSART (ZODA) and M_BEST_BSA/ACTVT (02);

Function-Based Sub-Rule 2 (Service Entry Sheet Acceptance):
ML81 (TCD) and M_EINK_FRG/FRGGR (A1) and M_EINK_FRG/FRGCO (X1 or X2) and M_BEST_B SA/ACTVT (02);

Risk 1 is defined as the combination of Function 1 and Function 2

The rule definition for Risk 1 is processed to achieve Function Level Risk Analysis. Function-Based Sub-Rule 1 is verified if in user/profile/roles authorization is verified for one of the following:
ME28 and M_EINK_FRG/FRGGR (CO) and M_EINK_FRG/FRGCO (C1) and M_BEST_BSA/BSART (ZODA) and M_BEST_BSA/ACTVT (02);
   or
ME28 and M_EINK_FRG/FRGGR (CO) and M_EINK_FRG/FRGCO (K1) and M_BEST_BSA/BSART (ZODA) and M_BEST_BSA/ACTVT (02);
   Function-Based Sub-Rule 2 is verified if in user/profile/roles authorization is verified for one of the following:
ML81 and M_EINK_FRG/FRGGR (A1) and M_EINK_FRG/FRGCO (X1) and M_BEST_BSA/ACTVT (02);
   or

ML81 and M_EINK_FRG/FRGGR (A1) and M_EINK_FRG/FRGCO (X2) and M_BEST_BSA/ACTVT (02);

Risk 1 is true if both Function-Based Sub-Rule 1 and Function-Based Sub-Rule 2 are verified. In the above example, ME28 and ML81 are action codes for specific pages of an application, M_EINK_FRG is a permission object having fields FRGGR and FRGCO, where field FRGGR may have values of at least CO and A1, and field FRGCO may have values of at least C1, K1, X1, and X2, M_BEST_BSA is a permission object having fields BSART, which has a value of ZODA in the sub-rule, and ACTVT, which has a value of 02.

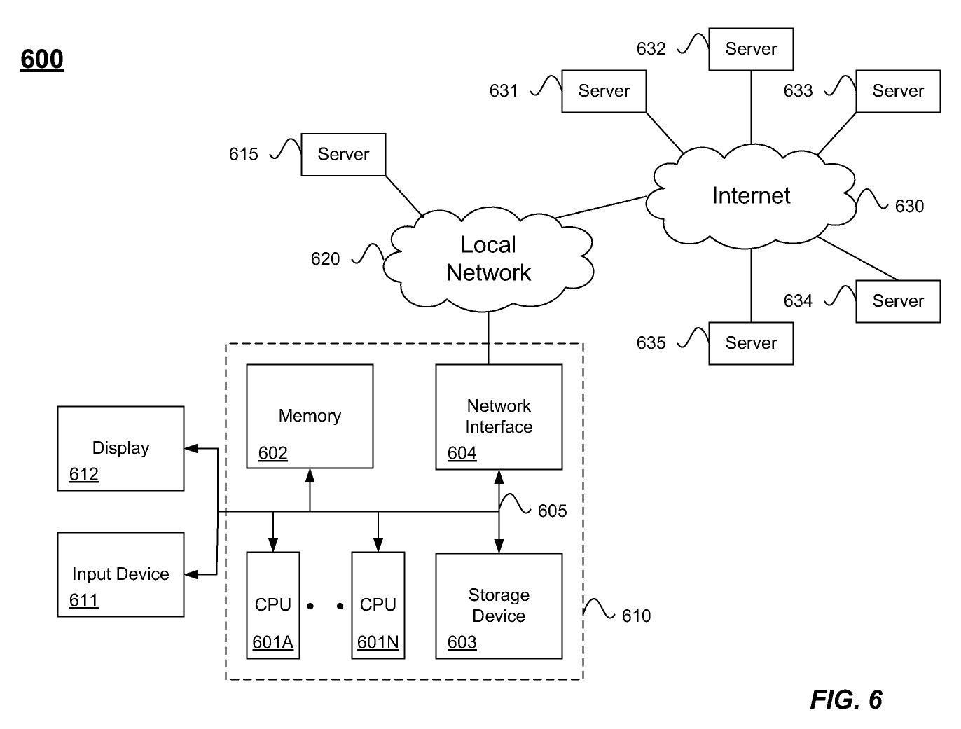

FIG. 6 is a block diagram of an example computer system and network 600 for implementing embodiments of the present invention. Computer system 610 includes a bus 605 or other communication mechanism for communicating information, and a processor 601 coupled with bus 605 for processing information. Computer system 610 also includes a memory 602 coupled to bus 605 for storing information and instructions to be executed by processor 601, including information and instructions for performing the techniques described above. This memory may also be used for storing variables or other intermediate information during execution of instructions to be executed by processors 601. Possible implementations of this memory may be, but are not limited to, random access memory (RAM), read only memory (ROM), or both. A storage device 603 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 603 may include source code, binary code, or software files for performing the techniques or embodying the constructs above, for example.

Computer system 610 may be coupled via bus 605 to an output device, such as a display 612, such as a cathode ray tube (CRT) or liquid crystal display (LCD), for displaying information to a computer user. An input device 611 such as a keyboard and/or mouse is coupled to bus 605 for communicating information and command selections from the user to processor 601. The combination of these components allows the user to communicate with the system. In some systems, bus 605 may be divided into multiple specialized buses.

Computer system 610 also includes a network interface 604 coupled with bus 605. Network interface 604 may provide two-way data communication between computer system 610 and the local network 620. The network interface 604 may be a digital subscriber line (DSL) or a modem to provide data communication connection over a telephone line, for example. Another example of the network interface is a local area network (LAN) card to provide a data communication connection to a compatible LAN. Wireless links using radio frequency communications are another example. In any such implementation, network interface 604 sends and receives electrical, electromagnetic, or optical signals that carry digital data streams representing various types of information.

Computer system 610 can send and receive information, including messages or other interface actions, through the network interface 604 to an Intranet or the Internet 630. In the Internet example, software components or services may reside on multiple different computer systems 610 or servers 631-635 across the network. The processes described above may be implemented on one or more servers, for example. A server 631 may transmit actions or messages from one component, through Internet 630, local network 620, and network interface 604 to a component on computer system 610. Different processes may be implemented on any computer system and send and/or receive information across a network, for example. In one embodiment, the techniques describe above may be implemented by software services on one or more servers 631-635, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
retrieving, in a first computer system, a plurality of user account data records from one or more external computer systems, each user account data record comprising:
a plurality of actions a user is authorized to perform in said one or more external software systems, and
for each action, one or more permissible data manipulation activities said user is capable of performing for a corresponding action,
wherein said actions are associated with a functional role of each user in said one or more software systems;
retrieving one or more risk analysis rules from a computer-readable medium coupled to said first computer system; and
applying, in a processor of said first computer system, the one or more risk analysis rules against one or more of said plurality of user account data records, each risk analysis rule comprising a plurality of different function-based sub-rules,
wherein each risk analysis rule applies a different function-based sub-rule to each different action in a particular user account data record, each function-based sub-rule being verified based on a particular action and at least one of the permissible data manipulation activities associated with said particular action, and
wherein the risk analysis rule is verified if each of the different function-based sub-rules for the different actions are verified.

2. The method of claim 1 wherein each action corresponds to a software application page a user is authorized to access, and the permissible data manipulation activities restrict the manipulation of data fields in said application page by said user.

3. The method of claim 1 wherein each action is stored as an action code in said user data account records.

4. The method of claim 3 wherein the one or more permissible data manipulation activities said user is capable of performing for a corresponding action are permission objects associated with said action codes, said permission objects having values indicating the activities said users are capable of performing in said one or more software systems.

5. The method of claim 4 wherein the permission objects correspond to specific data fields of an application page and the permission object values specify one or more data manipulations a user may perform on said data fields, and wherein each function-based sub-rule comprises a Boolean combination of one or more permission object values and at least one action code value.

6. The method of claim 4 wherein each function-based sub-rule comprises a Boolean combination of one action code and a plurality of permission objects each having specified values.

7. The method of claim 1 wherein user account data records from two or more external software systems correspond to a single user, the method further comprising merging said account data records prior to applying said risk analysis rules.

8. The method of claim 1 further comprising retrieving a plurality of risk analysis rules and, based on the actions in the retrieve user account data records, eliminating risk analysis rules from said plurality of risk analysis rules to produce said one or more risk analysis rules to be applied against said one or more of said plurality of user account data records.

9. The method of claim 8 wherein the risk analysis rules are eliminated if a risk analysis rule does not include an activity code in any of said user account data records, and wherein the activity codes specify particular application pages in at least one of the external software systems.

10. The method of claim 1 further comprising aggregating the results of each risk analysis rule and sending the aggregated results to a reporting software component.

11. A computer-readable medium containing instructions for controlling a computer system to perform a method, the method comprising:
retrieving a plurality of user account data records from one or more external software systems, each user account data record comprising:
a plurality of actions a user is authorized to perform in said one or more external software systems, and
for each action, one or more permissible data manipulation activities said user is capable of performing for a corresponding action,
wherein said actions are associated with a functional role of each user in said one or more software systems; and
applying one or more risk analysis rules against one or more of said plurality of user account data records, each risk analysis rule comprising a plurality of different function-based sub-rules,
wherein each risk analysis rule applies a different function-based sub-rule to each different action in a particular user account data record, each function-based sub-rule being verified based on a particular action and at least one of the permissible data manipulation activities associated with said particular action, and
wherein the risk analysis rule is verified if each of the different function-based sub-rules for the different actions are verified.

12. The computer-readable medium of claim 11 wherein each action corresponds to a software application page a user is authorized to access, and the permissible data manipulation activities restrict the manipulation of data fields in said application page by said user.

13. The computer-readable medium of claim 11 wherein each action is stored as an action code in said user data account records.

14. The computer-readable medium of claim 13 wherein the one or more permissible data manipulation activities said user is capable of performing for a corresponding action are permission objects associated with said action codes, said permission objects having values indicating the activities said users are capable of performing in said one or more software systems.

15. The computer-readable medium of claim 14 wherein the permission objects correspond to specific data fields of an application page and the permission object values specify one or more data manipulations a user may perform on said data fields, and wherein each function-based sub-rule comprises a Boolean combination of one or more permission object values and at least one action code value.

16. The computer-readable medium of claim 14 wherein each function-based sub-rule comprises a Boolean combination of one action code and a plurality of permission objects each having specified values.

17. The computer-readable medium of claim 11 wherein user account data records from two or more external software systems correspond to a single user, the method further comprising merging said account data records prior to applying said risk analysis rules.

18. The computer-readable medium of claim 11 further comprising retrieving a plurality of risk analysis rules and, based on the actions in the retrieve user account data records, eliminating risk analysis rules from said plurality of risk analysis rules to produce said one or more risk analysis rules to be applied against said one or more of said plurality of user account data records.

19. The computer-readable medium of claim 18 wherein the risk analysis rules are eliminated if a risk analysis rule does not include an activity code in any of said user account data records, and wherein the activity codes specify particular application pages in at least one of the external software systems.

20. The computer-readable medium of claim 11 further comprising aggregating the results of each risk analysis rule and sending the aggregated results to a reporting software component.
